(19) United States
(12) Patent Application Publication
(10) Pub. No.: US 2006/0004587 A1
(43) Pub. Date: Jan. 5, 2006

(54) System for distribution of hot and cold water and metering of same

(76) Inventor: C. Garey Willbanks JR., Sequin, TX (US)

Correspondence Address: FULBRIGHT & JAWORSKI, LLP, 1301 MCKINNEY, SUITE 5100, HOUSTON, TX, 77010-3095, US

(21) Appl. No.: 10/882,821

(22) Filed: Jul. 1, 2004

(51) Int. Cl. G06F 17/60

(52) U.S. Cl. 705/1; 705/40

(57) ABSTRACT

A system and a method is provided by distributing and monitoring hot and cold water supplied to individual building units in a multi-unit building or multi-unit building complexes, and billing and distributing revenues from the individual building units. The system and method comprise the use of a central water heating unit for heating water, a first distribution line connected to the heating unit, delivery lines extending from the first distribution line to individual building units, a second distribution line for distributing cold water, individual meters for measuring the quantity of either hot or cold water supplied to each building unit, a billing system for invoicing individual units and a distribution system for allocating revenue back to the building owner and to a maintenance company for maintaining the central water heating unit.

### 1. FIELD OF THE INVENTION

This present invention relates to a system for water distribution. More specifically, the present invention relates to a system for delivering hot and cold water to individual building units in a multi-unit building complex, measuring the quantity of hot or cold water delivered to each individual building unit, allocating the amount of non-measured cold or hot water usage based on the measured amount of hot or cold water usage, and billing, collecting and distributing revenue based on measured or allocated values.

### 2. BACKGROUND OF THE RELATED ART

As the number of people living in cities continues to increase, the use of residential apartment buildings, condominiums, and other multi-unit buildings has also increased. Multi-unit buildings create a special problem when it comes to metering supplied utilities to individual units within the building.

When a building owner pays all of the utility costs for the building, the owner generally tries to recover these costs in the rent charged to his tenant. Several problems exist with this method of supplying utilities. First, because most tenants have a lease that provides for a fixed rent amount, the building owner must take the risk of fluctuations in the cost of supplying utilities. Additionally, because individual tenants are not charged by their actual usage, there is no financial incentive to conserve.

To avoid the risk of utility cost fluctuations, many building owners prefer to have individual building unit tenants charged directly for their utility usage. For utilities such as electricity, individual meters are often installed and the building-unit tenant is billed directly for his usage. This reduces the financial risk to the building owner and provides the incentive to conserve electricity.

Despite the advantages associated with directly allocating or billing utilities, another problem exists for supplying water to individual building units. Water is generally supplied by the municipal district or other regional water supplier at ambient or near ambient temperatures. This has traditionally been referred to as “cold water.” Cold water can be supplied directly to individual building units and tenants can be billed directly for their cold water usage.

However, people are also accustomed to having “hot water” directly accessible in their homes. Therefore, the owner of multi-unit buildings needs to provide some mechanism for delivering water, heated to acceptable temperatures, to their tenants. Building owners have had the choice of installing a central water heating unit or installing water heating units in individual building units.

It has been generally recognized that central heating units, especially those using natural gas to heat water, are preferable to individual heating units. However, because it is difficult to allocate the cost of operating a central system to individual building units, this cost is generally born by the building owners. Utility regulations often aggravate this problem by preventing building owners from charging for their time spent in trying to allocate and bill tenants for water heating costs.

As a result, most owners of multi-unit buildings opt to install individual water heaters in each building unit. This type of system clearly allocates hot water cost to the tenant. However, individual water heaters, especially electric water heaters, are more expensive to operate and are less energy efficient than a central gas water heating unit. Additionally, the cost of maintaining water heating units in individual building units is more expensive than maintaining a central system.

Therefore, there is a need for an improved system for allocating water costs associated with the usage of the water and the energy and an improved system for billing and allocation of receipts following a billing operation.

### 3. SUMMARY OF THE INVENTION

Briefly, the present invention is a system for distributing and measuring cold or hot water supplied to individual building units in multi-unit building complexes and for invoicing and distributing revenue for hot and cold water usage. Broadly, the system includes a central water heating unit for heating water, a first distribution line connected to the central heating unit, delivery lines extending from the first distribution line to individual building units, a second distribution line for distributing cold water, individual meters within each cold or hot water delivery line to measure the quantity of cold or hot water supplied to each building unit, a billing system for invoicing individual units, and a distribution system for allocating revenue back to the building owner for payment of water and natural gas and for payment to a maintenance company for maintaining the central water heating unit and the distributions lines.

The method of the present invention includes providing the system, heating the water in the central heating unit, delivering the hot water into a first distribution line, supplying hot water from the first distribution line to a delivery line for each individual building unit, delivering the cold water into a second distribution line, delivering cold water through a delivery line to each individual unit, measuring the quantity of either hot or cold water withdrawn from the delivery line to each individual unit, allocating hot or cold water usage based on the measurement of cold or hot water usage withdrawn at each individual unit, generating an invoice for each individual unit reflecting the amount of cold and hot water used by each unit, collecting revenue from each individual unit based on the amount of hot and cold water used, paying a portion of the receipts to the building owner for payment to the utility companies, and paying a portion of the revenue received from each individual unit for maintenance and operation of the hot and cold water distribution system. This method allows building owners to use a more energy efficient central water heating system, yet also allows for the efficient allocation of hot water costs to building unit tenants based upon actual hot water usage.

### 4. BRIEF DESCRIPTION OF THE DRAWINGS

A better understanding of the invention can be obtained when the detailed description set forth below is reviewed in conjunction with the accompanying figures as shown:

FIG. 1 is a schematic diagram of a hot and cold water distribution and measurement system according to the present invention.

FIG. 2 is a flow chart reflecting the distribution of invoices and collection of revenue as set forth in the present invention.

FIG. 3 is an alternate embodiment of the present invention.

### 5. DETAILED DESCRIPTION OF THE INVENTION

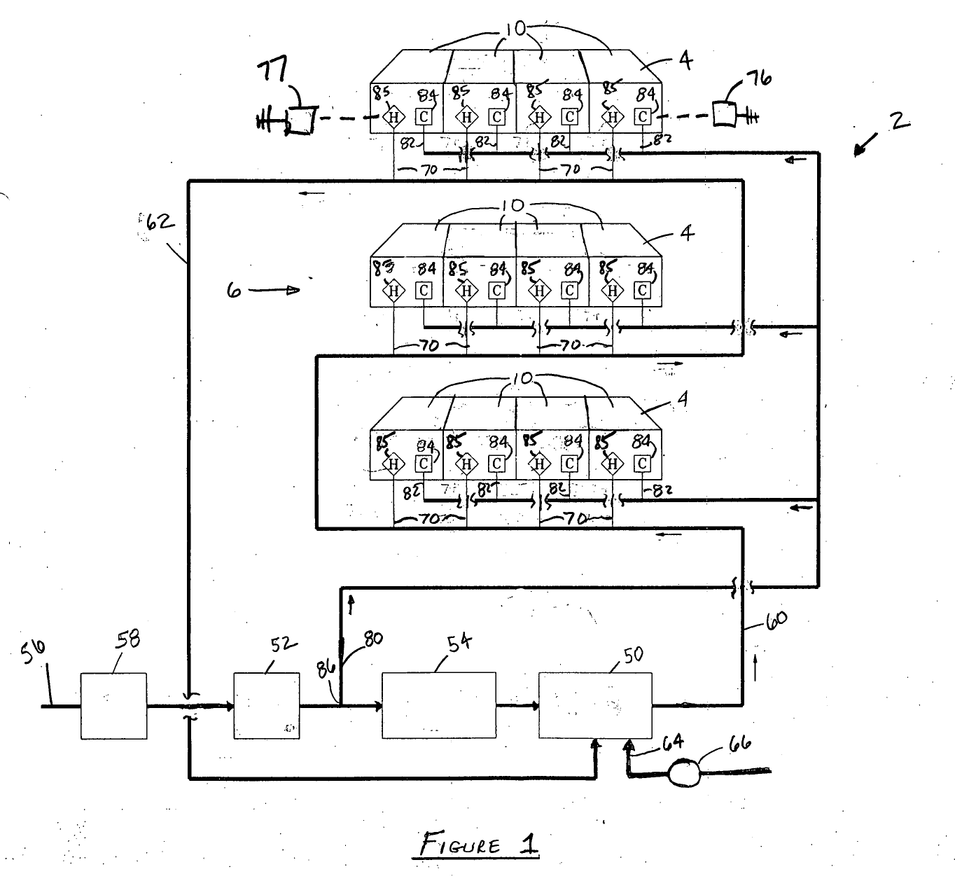

As shown in FIG. 1, the present invention includes a system for heating, distributing, and measuring water supplied to individual building units 10 in a multi-unit building complex 4. System 2 allows a building owner to provide a higher quality hot water on a more cost efficient basis and to allocate the cost of operating the system to tenants of individual building units based on their usage. FIG. 1 shows an embodiment of system 2 applied to a building complex having three buildings 4 with four building units 10 in each building 4. As will be recognized, system 2 can be utilized in building complexes having any number of buildings or any number of building units within each building. Further, system 2 is equally applicable to a single multi-unit building with multiple floors. Furthermore, the present invention is not limited to residential application. It may be used in commercial application wherever individual hot water metering is beneficial.

Potable water is supplied to system 2 from a potable water line 56. Potable water line 56 can be connected to a municipal water system or other supply or source of potable water. A bulk water supply meter 58 measures the total quantity of water supplied to a building complex. Supply meter 58 is of a variety known to those skilled in the plumbing art and which is typically installed in potable water line 56 for billing purposes.

Water from potable water line 56 can be routed directly into water heating unit 50 to be heated or optionally, the water can be treated by a filter 52 and/or softened in water softener 54, if desirable. The ability to provide a higher quality water to individual units 10 by filtering and softening water in a central system and allocating the costs of operating filter 52 and softener 54 based on actual water usage is another advantage of the present invention.

Filter 52 is a variety known to those skilled in the plumbing art for filtering sediment and other debris from water lines. Typically, filter 52 has a 20 micron filtering element. However, the degree of filtration can vary depending upon the water source and other factors commonly known to those skilled in the art of water filtration. Similarly, water softener 54 is of a type commonly known to remove minerals and soften potable water, such Model A150F29 manufactured by the Bruner Corporation of Milwaukee, Wis. Water softener 54 can prevent scale and other types of buildups in central water heating unit 50.

As will be appreciated by those skilled in the art, central water heating unit 50 can be of any design capable of adequately supplying hot water to all building units 10 in buildings 4. However, to take full advantage of the energy efficiency associated with centralized water heating, preferably central water heating unit 50 burns natural gas to heat the water. Other fuels or electricity can also be utilized to heat water in central water heating unit 50 depending on cost and availability of other sources. Typically, central water heating unit 50 should be capable of delivering water at about 120° F.-140° F. An acceptable central water heating unit 50 would be the Delta series manufactured by Raypak, Inc. of Westlake Village, Calif.

Natural gas is supplied to central water heating unit 50 to operate unit 50 and provide a heat source through fuel supply connection 64. The quantity of natural gas supplied to central water heating unit 50 can be measured with a standard fuel meter 66, commonly known and used.

After heating the water, central water heating unit 50 delivers hot water into distribution line 60. Distribution line 60 extends throughout the multi-unit building complex 6. Those skilled in the art will recognize that its size is dependant upon the flow rate required by the particular configuration of system 2. Although FIG. 1 shows distribution line 60 as a single continuous water line, it will be appreciated that depending upon the layout of the multi-unit building complex 6, distribution line 60 may actually include multiple branched connections. Distribution line 60 can be constructed from copper, plastic or steel or other suitable materials as are commonly used in plumbing systems.

Distribution line 60 can have a return line portion 62 that returns water not withdrawn from system 2 to the central water heating unit 50. Return line portion 62 allows hot water to be constantly circulated from central water heating unit 50 to distribution line 60 and back through return line portion 62 to central water heating unit 50. Circulation of hot water prevents the water temperature of system 2 from decreasing due to heat loss to the atmosphere. Alternatively, return line portion 62 can be eliminated and an electrical or other form of heat tracing can be used to prevent the water temperature from dropping in system 2 without circulation.

Distribution line 60 supplies hot water to delivery lines 70 for use in individual building units 10. In FIG. 1, for each building unit 10, a delivery line 70 extends from distribution line 60 into building unit 10. Inside each building unit 10, delivery line 70 connects to the building unit's plumbing system to supply water to various hot water taps 72 including sinks, bathtubs, showers, dishwashers, etc. Like the distribution line 60, the size and construction of delivery lines 70 can be determined by one skilled in the art of plumbing based on the particular configuration of system 2.

For illustrative purposes only, a single distribution line 60 has been shown in FIG. 1 with a delivery line 70 branching off the distribution line into each individual building unit 10. It will be appreciated by one skilled in the art that the distribution system may vary from that shown in FIG. 1 but still practice the present invention. For example, while there may be a single distribution line 60 leaving central water heating unit 50, that line may branch off into a series of lines, each one going to a different building, and at that point that distribution line may then branch off into individual building units. It will be apparent to one skilled in the art that there are a virtually limitless number of distribution configurations for distributing hot water once it leaves the central water heating unit 50 for delivery to individual building units, consistent with the teachings of the present invention as set forth herein. It is, therefore, intended that all permeations and variations of the distribution system fall with the spirit and scope of the present invention as claimed.

Additionally, system 2 includes a means to distribute and measure cold water delivered to individual building units 10. A cold water distribution line 80 extends from potable water line 56 at a point 86 after main meter 58 and before central water heating unit 50. Cold water distribution line 80 delivers cold water to cold water delivery lines 82. Each building unit 10 has a cold water delivery line 82 that connects cold water distribution line 80 to the building unit's plumbing system. Each cold water delivery line 82 may have a cold water meter 84 such as is commonly known and used in the plumbing arts. Alternatively, each hot water delivery line 70 may have a hot water meter 85 connected thereto, such as is commonly know and used in the plumbing arts. As will be appreciated, each water meter 84 or 85 should contain some form of an indicator that displays the total quantity of water withdrawn. The indicator may be in the form of a local readout on meter 84 or 85, or alternatively can be generated from a signal sent by data transmission means 76 of meter 84, or sent by a transmission line 77 of meter 85, at a remote location. Remote meter reading systems are well known and examples of such systems are disclosed in U.S. Pat. Nos. 5,270,704 and 5,252,967.

Thus, in practicing the present invention, the operator would use either installed hot water meters to measure hot water usage at individual units and then allocate non-measured cold water usage, or use installed cold water meters to measure cold water usage at individual units and then allocate non-measured hot water usage.

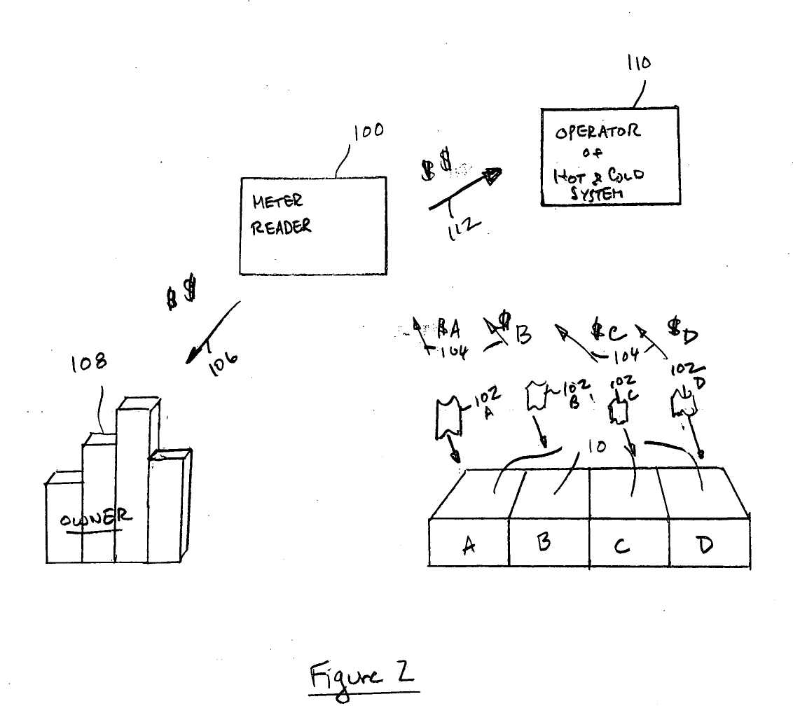

Referring now to FIG. 2, the present invention also includes an improved system for billing and distribution of revenues from individual units in a manner which allocates responsibility among different entities thereby improving on the operation and efficiency of the distribution system. The billing system begins with a meter reading company 100 responsible for the periodic reading of the individual meters 84 or 85 of each unit. If cold water usage is measured at the cold water meter 84 of individual units, the amount of hot water usage may be allocated based on a similar percentage. For example, if a residential unit uses 1% of the cold water after adjustments for common area water usage (i.e., swimming pools, lawn sprinklers, etc.), then that residential unit would be allocated 1% of the hot water usage after any adjustments for common hot water usage such as a common cloths washer area. Similarly, if hot water usage is measured, each residential unit would be allocated cold water usage based on the percentage of hot water usage after adjustments for common area usage for hot and cold water.

Once the reading and allocation is completed, invoices 102A-D, for example, are generated for each individual unit 10A-D, for example, reflecting the amount due for both cold and hot water usage and energy usage associated with the generation of the hot water. Once the revenue 104A-D is received from each individual unit, the reading or collection company 100 is responsible for the distribution of some of the revenue 106 back to the building owner 108 and some 112 to the operator 110 of the distribution system. Obviously, the use of four individual units (A-D) in FIG. 2 is for illustrative purposes only and is not to be interpreted in a limiting manner. The invention can accommodate any number of individual units.

Typically, the building owner is responsible for paying for water usage and energy consumption. Accordingly, the receipts for that period would reflect the monies needed to satisfy those obligations. It should be understood that the billing and collection responsibilities may be consolidated into several entities or divided among various entities. For example, the building owner may assume responsibility for reading each meter and invoicing each individual tenant, collecting the income and then distributing a portion back to the operator of the distribution system 110. Operator 110 would be responsible for maintaining the system. Alternatively, the building owner 108 may hire a third party 100 to individually read each meter and then invoice tenants, or there may be a separate contractor for the reading of each meter and for the invoicing and the collection of revenue from each tenant. The consolidation or allocation of obligations with respect to billing and collections is not limited by this disclosure. Any such combination is assumed to fall within the spirit and scope of the claimed invention.

As can now be appreciated, the present invention provides a system and a method for heating, distributing, and measuring the supply of water delivered to individual building units in multi-unit building complexes. The method of the present invention allows building owners to provide a higher quality hot water distribution, to allocated associated costs and to bill and collect in a more efficient manner.

The method of the present invention, which utilizes the system of the present invention, begins by supplying water and fuel to a central water heating unit which heats water. The central heating unit then delivers hot water into a first distribution line. The first distribution line supplies hot water to individual building units through individual delivery lines from the first distribution line. Cold water is also supplied from a separate cold water distribution line into individual cold water delivery lines extending from the cold water distribution line into each individual building unit. Periodically, the amount of hot or cold water consumed by each individual building unit is recorded or measured and the amount of non-measured cold or hot water usage is then allocated based upon the amount of measured hot or cold water usage. An invoice is then generated for each building unit based on the amount of such cold and hot water usage. Revenue received from such invoices are distributed. Referring to FIG. 2, distribution of income from the meter reading company to the building owner responsible for paying the water and energy consumption bills is provided for. Additionally, in all likelihood, a portion would be allocated to the operating company responsible for maintaining and operating the hot water system.

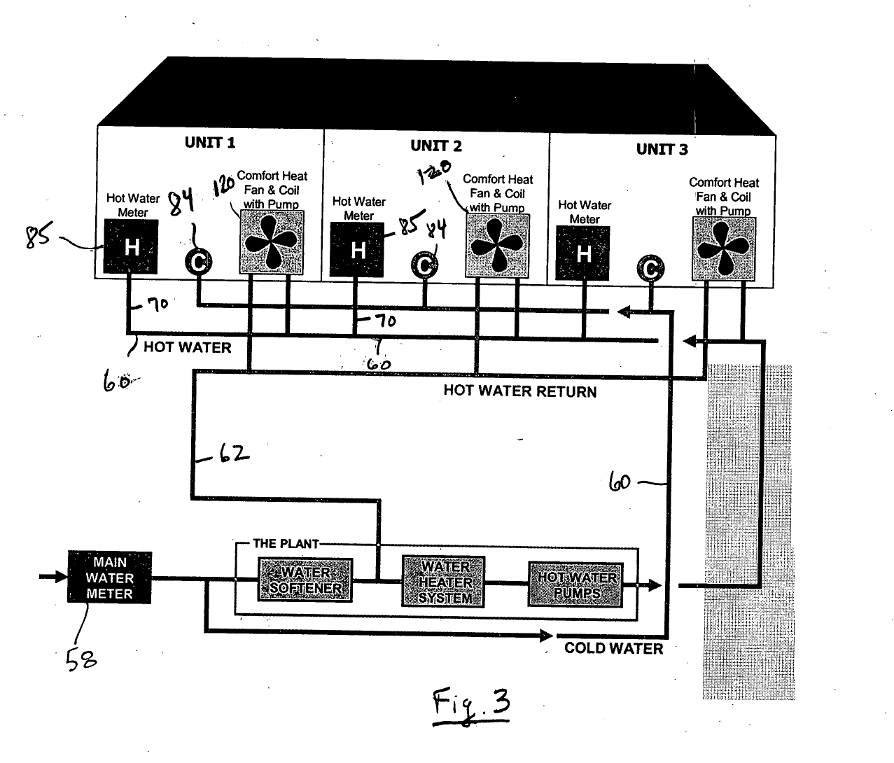

FIG. 3 is an alternate embodiment of the present invention which is identical to the embodiment shown in FIG. 1 and described above except that it includes the addition of a heating system 120 for each residential unit which is supplied with heated water off the distribution line 60. Such an air space water heater system 120 is commonly known to those skilled in the art and may also be referred to from time-to-time as a comfort heat fan and coil system, Such a unit, for example, is commercially available as Series RAQ, manufactured by First Operations LP of Dallas, Tex. Each such comfort heat fan and coil system includes a circulating water radiator and a fan for distributing the heat emanating from the radiator. Each fan unit includes a time clock which records the amount of time the fan has run over a given period. Such timed fans are also well know to those skilled in the art and are available from the Minol Company of Addison, Tex. as model number RTM-3024. The hot water used by each comfort heat fan and coil system 120 is not monitored. Rather, the allocation of hot water usage for each system 120 is based on the time the fan operates. In this manner, relying on the clock recordings of each comfort heat fan and coil system 120 for the entire complex, an allocation can be made for each individual residential unit of the hot water usage for the air space heater by taking a percentage of the total estimated hot water usage based on all the time clock readings for the complex. The total estimated hot water usage for all the comfort heat fan and coil systems of the complex would not include hot water usage either measured or allocated as previously described above using the individual meters 84 or 85 of each residential unit.

The foregoing disclosure and description of the invention are illustrative and explanatory thereof, and various changes in size, shape, and materials, as well as in the details of the performance of the method may be made without departing from the spirit of the invention.

What is claimed is:

1. A system for heating, distributing, measuring, and billing potable water supplied to individual building units in a multi-unit building complex from a potable water source, comprising:
a central water heating unit;
a first distribution line in fluid communication with said central heating unit extending throughout the multi-unit building complex and having a return line portion allowing heated water to circulate through the multi-unit building complex and return to said central heating unit;
a delivery line extending from said first distribution line to each individual building unit;
a cold water distribution line extending throughout the multi-unit building complex;
cold water delivery lines extending from said cold water distribution line to each individual building unit;
a meter for each individual building unit for measuring the quantity of heated or cold water supplied; and
an billing and income allocation system including:
means for recording the amount of measured heated or cold water usage at each said meter,
means for allocating the amount of non-measured cold or heated water used at each individual building unit based on the measured water usage for that individual building unit,
means for generating an invoice for each individual building unit based on the amount of such cold and heated water usage, and
means for distributing receipts for each said invoices.

2. The system of claim 1, further comprising a water heating system in fluid communication with said first distribution line.

3. The system of claim 1, further comprising a central water softening unit.

4. The system of claim 1, further comprising a central water filter.

5. The system of claim 1, further comprising a fuel meter for measuring the quantity of fuel supplied to said central heating unit.

6. The system of claim 1, wherein said recording means comprises a means for transmitting data to a remote location.

7. A method of heating, distributing, measuring and billing water supplied to individual building units in a multi-unit building complex comprising the steps of:
providing a central water heating unit, a first distribution line for supplying heated water, a delivery line from said first distribution line to each individual building unit, a cold water distribution line, a cold water delivery line to each individual building unit, and a cold water meter for measuring the quantity of cold water supplied by cold water delivery for each individual building unit;
heating water in the central heating unit;
delivering hot water from the central water heating unit into the first distribution line;
supplying hot water from the first distribution line to the delivery line for individual building units;
supplying cold water from the cold water distribution line into the cold water delivery line for individual building units;
measuring the quantity of hot or cold water usage into each individual building unit;
allocating the amount of non-measured cold or hot water used at each individual building unit based on the measured amount of water usage for that individual building unit;
generating an invoice for each individual building unit based on the amount of such cold and heated water usage; and
distributing receipts for each said invoices.

8. The method of claim 7 further comprising the step of:
returning excess hot water from the first distribution line to the central heating unit.

9. A method of heating, distributing, measuring and billing water supplied to individual building units in a multi-unit building complex, comprising the steps of:
providing a central fuel-fired water heating unit, a first distribution line for supplying heated water, a delivery line from said first distribution line to each individual building unit, a cold water distribution line, a cold water delivery line to each individual building unit, and a cold water meter for measuring the quantity of cold water supplied by cold water delivery for each individual building unit;
supplying water and fuel to the central fuel-fired water heating unit;
heating water in the central heating unit;
delivering hot water from the central water heating unit into the distribution line;
supplying hot water from the distribution line to the delivery line for individual building units;
supplying cold water from the cold water distribution line into the cold water delivery line for individual building units;
measuring the quantity of hot or cold water usage into each individual building unit;
allocating the amount of non-measured cold or hot water used at each individual building unit based on the measured amount water usage for that individual building unit;
generating an invoice for each individual building unit based on the amount of such cold and heated water usage; and
distributing receipts for each said invoices.

10. The method of claim 9 further comprising the steps of:
providing a fuel meter for measuring the quantity of fuel supplied to the central heating unit;
recording the quantity of fuel used in the central water heating unit; and
allocating costs of supply fuel to the central heating unit to individual building units.

11. A system for heating, distributing, measuring, and billing potable water supplied to individual building units in a multi-unit building complex from a potable water source, comprising:
a central water heating unit;
a first distribution line in fluid communication with said central heating unit extending throughout the multi-unit building complex and having a return line portion allowing heated water to circulate through the multi-unit building complex and return to said central heating unit;
a delivery line extending from said first distribution line to each individual building unit;
a cold water distribution line extending throughout the multi-unit building complex;
cold water delivery lines extending from said cold water distribution line to each individual building unit;
a meter for each individual building unit for measuring the quantity of heated or cold water supplied;
a water heating system in fluid communication with said first distribution line; and
an billing and income allocation system including:
means for recording the amount of measured heated or cold water usage at each said meter,
means for allocating the amount of non-measured cold or heated water used at each individual building unit based on the measured water usage for that individual building unit,
means for generating an invoice for each individual building unit based on the amount of such cold and heated water usage, and
means for distributing receipts for each said invoices.
